(19) United States
(12) Patent Application Publication
(10) Pub. No.: US 2025/0237527 A1
(43) Pub. Date: Jul. 24, 2025

(54) INFORMATION PROCESSING APPARATUS, INFORMATION PROCESSING METHOD, AND NON-TRANSITORY COMPUTER READABLE STORAGE MEDIUM

(71) Applicant: LY Corporation, Tokyo (JP)

(72) Inventor: Takuro MORI, Tokyo (JP)

(21) Appl. No.: 19/017,184

(22) Filed: Jan. 10, 2025

(30) Foreign Application Priority Data
Jan. 19, 2024 (JP) 2024-006979

(51) Int. Cl. G01C 21/00; G06F 16/28; G06F 16/29

(52) U.S. Cl. CPC G01C 21/3811; G06F 16/287; G06F 16/29

(57) ABSTRACT

An information processing apparatus according to the present application includes an acquisition unit, a classification unit, and a provision unit. The acquisition unit acquires sojourner information including a plurality of pieces of information in a specific region. The classification unit classifies the specific region into a plurality of regions corresponding to characteristics of sojourners based on the sojourner information acquired by the acquisition unit. The provision unit provides map information indicating information indicating a characteristic at the position of each of two or more regions among a plurality of regions in the specific region.

### CROSS-REFERENCE TO RELATED APPLICATIONS

The present application claims priority to and incorporates by reference the entire contents of Japanese Patent Application No. 2024-006979 filed in Japan on Jan. 19, 2024.

### BACKGROUND OF THE INVENTION

### 1. Field of the Invention

The present invention relates to an information processing apparatus, an information processing method, and a non-transitory computer-readable storage medium.

### 2. Description of the Related Art

There has been known a technique for working out a sales strategy or the like in a store. For example, Japanese Patent Application Laid-open No. 2016-170778 proposes a technique for analyzing a trading area designated by a client device.

However, in the related art explained above, an analysis of a trading area can be performed but there is room for further improvement in order to support an analysis of a specific region such as the trading area.

### SUMMARY OF THE INVENTION

An information processing apparatus according to the present application includes an acquisition unit, a classification unit, and a provision unit. The acquisition unit acquires sojourner information including a plurality of pieces of information in a specific region. The classification unit classifies the specific region into a plurality of regions corresponding to characteristics of sojourners based on the sojourner information acquired by the acquisition unit. The provision unit provides map information indicating information indicating a characteristic at the position of each of two or more regions among a plurality of regions in the specific region.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a diagram for explaining information processing according to an embodiment;

FIG. 2 is a diagram illustrating an example of a configuration of an information processing system according to the embodiment;

FIG. 3 is a diagram illustrating an example of a configuration of an information processing apparatus according to the embodiment;

FIG. 4 is a diagram illustrating an example of a user information table stored in a user information storage unit of the information processing apparatus according to the embodiment;

FIG. 5 is a diagram illustrating an example of a prompt used by a classification unit of a processing unit in the information processing apparatus according to the embodiment;

FIG. 6 is a diagram illustrating an example of map information provided by a provision unit of the processing unit in the information processing apparatus according to the embodiment and displayed on a terminal device;

FIG. 7 is a flowchart illustrating an example of information processing by the processing unit of the information processing apparatus according to the embodiment; and

FIG. 8 is a hardware configuration diagram illustrating an example of a computer that implements the functions of the information processing apparatus according to the embodiment.

### DETAILED DESCRIPTION OF THE PREFERRED EMBODIMENTS

A mode (hereinafter referred to as “embodiment”) for implementing an information processing apparatus, an information processing method, and a non-transitory computer-readable storage medium according to the present application are explained in detail below with reference to the drawings. Note that the information processing apparatus, the information processing method, and the non-transitory computer-readable storage medium according to the present application are not limited by the embodiment. In addition, embodiments can be combined as appropriate within a range in which processing contents do not contradict one another. In the following embodiments, the same parts are denoted by the same reference numerals and signs, and redundant explanation is omitted.

### 1. Example of Information Processing

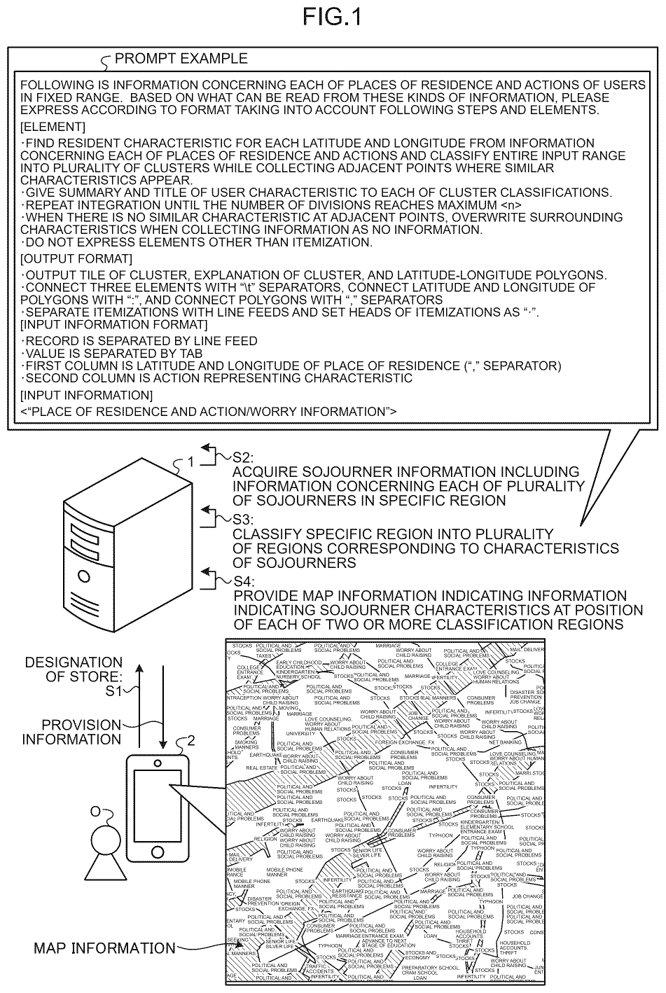

First, an example of information processing according to the embodiment is explained with reference to FIG. 1. FIG. 1 is a diagram for explaining information processing according to an embodiment;

An information processing apparatus 1 illustrated in FIG. 1 is an information processing apparatus that cooperates with a terminal device 2 of a service user O and provides various services to the service user O online and is implemented by, for example, one or more servers or a cloud system. The terminal device 2 is, for example, a smartphone, a tablet terminal, or a personal computer.

The service provided to the service user O by the information processing apparatus 1 is, for example, a region characteristic analysis service and, for example, map information in which information corresponding to characteristics of sojourners in a specific region designated by the service user O is arranged is transmitted to the terminal device 2 of the service user O.

As illustrated in FIG. 1, the information processing apparatus 1 receives designation of a region by the service user O (step S1). In the following explanation, a region designated by the service user O is referred to as specific region.

In step S1, for example, when receiving a region characteristic information request including region information indicating the region designated by the service user O and transmitted from the terminal device 2, the information processing apparatus 1 receives the designation of the region by the service user O based on the area information included in the region characteristic information request.

For example, the service user O operates the terminal device 2 and causes the terminal device 2 to transmit a map information request to the information processing apparatus 1. When receiving the map information request transmitted from the terminal device 2, the information processing apparatus 1 transmits the map information to the terminal device 2. When receiving the map information transmitted from the information processing apparatus 1, the terminal device 2 displays the received map information.

The service user O can designate a region desired to be set as a target of a region characteristic analysis in the map indicated by the map information displayed on the terminal device 2. When the region is designated by the service user O, the terminal device 2 transmits a region characteristic information request including, as designated region information, information indicating the region designated by the service user O to the information processing apparatus 1.

Subsequently, the information processing apparatus 1 acquires sojourner information including information concerning each of a plurality of sojourners in the specific region that is the region for which the designation has been received in step S1 (step S2). The sojourners in the specific region are, for example, residents who are users residing in the specific region, workers who are users working in the specific region, and visitors to the specific region.

The sojourner information includes sojourn position information indicating sojourn positions of the sojourners as the information concerning the sojourners. The sojourn positions of the sojourners are place of residence or places of work when the sojourners are residents in the specific region, are places of work when the sojourners are workers in the specific region, and are visit places when the sojourners are visits to the specific region.

The information processing apparatus 1 can acquire, for example, sojourner information including information concerning one or more types of sojourners satisfying a specific condition among a plurality of types of sojourners including a resident, a place of work, and a visitor. The specific condition is, for example, information set by the service user O. The information indicating the specific condition is included in, for example, the region characteristic information request.

In addition, the sojourner information includes, as the information concerning the sojourners, one or more pieces of information satisfying the specific condition among action information indicating actions of the sojourners and worry information indicating worries of the sojourners. The action information indicating the actions of the sojourners includes, for example, information indicating online actions of the sojourners and information indicating offline actions of the sojourners.

The online actions of the sojourners are, for example, search actions (for example, web searches) of the sojourners, online content browsing of the sojourners, and the like. The online content is, for example, a blog article, a news article, video content, music content, and posted content to an SNS but is not limited to such an example.

The information indicating the offline actions of the sojourners includes, for example, information indicating places (stores and facilities) used by the sojourners and information indicating use content thereof, information indicating means of transportation used by the sojourners and information indicating sections thereof, and information indicating moving routes on which the sojourners moved.

The use content of the use places, which are the places used by the sojourners, includes, for example, payment amounts and an average payment amount of the sojourners at the use place, content and a genre of purchased commodities or purchased services of the sojourners at the use place, and stay times and an average stay time of the sojourners at the use place but is not limited to such an example. The payment amounts and the average payment amount of the sojourners at the use place are, for example, settlement amounts and an average settlement amount of the sojourners at the use place but are not limited to such an example.

The worry information indicating the worries of the sojourners is, for example, information indicating worries concerning health, child raising, personal relationships, carriers, household accounts, and assets but is not limited to such an example. The worry concerning health is, for example, a worry concerning physical health such as illness and poor physical condition, and a worry concerning mental health such as stress and manic depression but is not limited to such an example.

The worry concerning child raising is, for example, a worry concerning growth of a child, a worry concerning child rearing of a child, a worry concerning school of a child, and a worry concerning infertility but is not limited to such an example. The worry concerning a personal relationship is, for example, a worry concerning a family relationship, a worry concerning a friendship, a worry concerning a relationship with a neighborhood resident, a worry concerning a love relationship, a worry concerning marriage, and a worry concerning communication but is not limited to such an example.

The worry about the carrier is, for example, a trouble about workplace relationship, a trouble about promotion, a trouble about job change, a trouble about skill improvement, and the like, but is not limited to such an example. The worry household accounts and assets is, for example, a worry concerning saving, a worry concerning investment, a worry concerning household accounts, and a worry concerning loans but is not limited to such an example.

The specific condition may include a condition of a type of an action instead of or in addition to the condition of the type of the sojourner. In this case, the information processing apparatus 1 acquires sojourner information including information concerning one or more types of actions satisfying the specific condition. The type of the action is, for example, an action in an online action of the sojourner or an action in an online action of the sojourner but may be a type obtained by subdividing the actions.

For example, when receiving a region characteristic information request and information concerning a time period designated by the service user O is included in the region characteristic information request, the information processing apparatus 1 can acquire only information concerning an action in the time period designated by the service user O.

The information processing apparatus 1 classifies, based on the sojourner information acquired in step S2, the specific region into a plurality of regions corresponding to the characteristics of the sojourners (step S3). For example, the information processing apparatus 1 finds characteristics of the sojourners for each latitude and longitude based on the sojourner information acquired in step S2 and classifies the entire specific region into a plurality of clusters corresponding to the characteristics of the sojourners while collecting adjacent points where the same or similar characteristics appear. The clusters include one or more regions in the specific region. The information processing apparatus 1 determines titles of the classified clusters.

For example, when information satisfying the specific condition among the action information indicating the action of the sojourner and the worry information indicating the worry of the sojourner is action information indicating the action of the sojourner, the information processing apparatus 1 classifies the specific region into a plurality of clusters corresponding to characteristics of the action of the sojourner.

Characteristics of the action of the sojourner is, for example, one characteristic among a keyword or a category used by the sojourner in an online search (for example, a web search, a blog search, a news search, and an SNS search), a type or a genre of content browsed online by the sojourner, a place or a genre where the sojourner often goes, or means of transportation used by the sojourner or a combination of two or more characteristics among these characteristics but is not limited to such an example.

For example, when information satisfying a specific condition among action information indicating an action of a sojourner and worry information indicating a worry of the sojourner is action information indicating a worry of the sojourner, the information processing apparatus 1 classifies the specific region into a plurality of clusters corresponding to characteristics of the worry of the sojourner. The characteristics of the worries of the sojourners are, for example, the worries classified as explained above but are not limited to the example explained above and various classifications are possible.

The information processing apparatus 1 performs the classification processing explained above using generative AI (Artificial Intelligence). The generative AI is, for example, text generation AI. The text generative AI is, for example, a large-scale language model learned to estimate and output the next token from an input token string and is, for example, a transformer-based model or an RNN (Recurrent Neural Network)-based model but may be a mixed model of these models or the like. The text generative AI may be a composite system combined with an identification machine or the like for preventing unauthorized use.

The transformer-based model is, for example, GPT (Generative Pre-trained Transformer) (registered trademark), PaLM2 (Pathways Language Model Version 2), or LLAMA (Large Language Model Meta AI) but is not limited to such an example. The RNN-based model is, for example, an RWKV (Receptance Weighted Key Value) but is not limited to such an example.

Note that the generative AI is desirably learned not to include personal information and the like in a generation result of the generative AI. The generative AI is disposed in an external information processing apparatus. The information processing apparatus 1 uses the generative AI via an API (Application Programming Interface). However, the generative AI may be disposed in the information processing apparatus 1.

Input information input to the generative AI is referred to as prompt. In the following explanation, the input information input to the generative AI is sometimes described as prompt. The prompt is, for example, information indicating an instruction, a request, or the like given to a language model in order to execute a specific task for language model.

For example, the information processing apparatus 1 inputs, to the generative AI, a prompt including instruction information that is information indicating an instruction to classify a specific region into regions of a plurality of clusters according to characteristics concerning one or more of actions and worries of a plurality of sojourners and a part or all of the information acquired in step S2 and causes the generative AI to output information indicating the regions of the plurality of clusters into which the specific region is classified.

For example, the information processing apparatus 1 inputs, to the generative AI, a prompt including instruction information that is information indicating an instruction to classify a specific region into regions of a plurality of clusters according to characteristics of actions of a plurality of sojourners and a part or all of the information acquired in step S2 and causes the generative AI to output information indicating regions of a plurality of clusters obtained by classifying the specific region according to of actions of the sojourners.

For example, the information processing apparatus 1 inputs, to the generative AI, a prompt including instruction information that is information indicating an instruction to classify a specific region into regions of a plurality of clusters according to characteristics of worries of a plurality of sojourners and a part or all of the information acquired in step S2 and causes the generative AI to output information indicating the regions of the plurality of clusters into which the specific region is classified according to the characteristics of the worries of the sojourners.

For example, the information processing apparatus 1 inputs, to the generative AI, a prompt including instruction information that is information indicating an instruction to classify a specific region into regions of a plurality of clusters according to characteristics indicated by combinations of actions and concerns of a plurality of sojourners and a part or all of the information acquired in step S2 and causes the generative AI to output information indicating the regions of the plurality of clusters into which the specific region is classified according to the characteristics indicated by the combinations of the actions and the worries.

For example, the information processing apparatus 1 inputs the prompt illustrated in FIG. 1 to the generative AI and causes the generative AI to output information indicating regions of a plurality of clusters obtained by classifying a specific region according to characteristics of actions of a sojourner. The instruction information of the prompt illustrated in FIG. 1 also includes information concerning an output format that defines how to output information indicating regions of a plurality of clusters obtained by classifying a specific region according to characteristics of actions of a sojourner.

In the example illustrated in FIG. 1, the information concerning the output format is information of a character string “· Output a title of a cluster, explanation of the cluster, and latitude and longitude polygons \n· Three elements are connected with “\t” separators, connect the latitude and longitude of the polygons with “:”, and connect the polygons with “,” separators, \n. Separate itemizations with line feeds, and set heads of the itemization are set as “·”.

The information processing apparatus 1 can classify one or more characteristics among actions and worries of a plurality of sojourners into two or more groups using a classification model instead of using the generative AI. The classification model is, for example, a GBDT (Gradient Boosting Decision Tree), a neural network, or the like, but is not limited to such an example.

The generative AI may be multi-modal generative AI or the like. The multi-modal generative AI is, for example, generative AI that generates at least one of text, an image, and voice from at least one of text, an image, and voice. The multi-modal generative AI is, for example, GPT-4 Turbo with vision, gemini, CM3Leon (Chameleon Multimodal Model), or the like but is not limited to such an example.

Note that the information processing apparatus 1 can perform the classification processing in step S3 with statistical processing instead of using the generative AI. For example, the information processing apparatus 1 extracts top n characteristics among characteristics of sojourners in a plurality of unit regions obtained by dividing the specific region. n is an integer equal to or larger than 2. Then, the information processing apparatus 1 classifies the entire specific region into a plurality of clusters corresponding to the characteristics of the sojourners while collecting adjacent unit regions where the same or similar characteristics appear.

Subsequently, based on the classification result in step S3, the information processing apparatus 1 provides map information indicating information indicating sojourner characteristics at the position of each of two or more classification regions among a plurality of classification regions, which are the plurality of regions classified in step S3, in the specific region (step S4).

For example, the information processing apparatus 1 transmits map information indicating information indicating sojourner characteristics at the position of each of two or more classification regions to the terminal device 2 to thereby provide, to the service user O, map information indicating the information indicating the sojourner characteristics at the position of each of the two or more classification regions.

The sojourner characteristic is a characteristic indicated by a characteristic of an action of the sojourner, a characteristic of a worry of the sojourner, or a combination of the action and the worry of the sojourner. The information indicating the sojourner characteristic is information indicating the sojourner characteristic with a character string (for example, a title) but may be information indicating the sojourner characteristic with a symbol or a figure or may be information indicating the sojourner characteristic with two or more of a character string, a symbol, and a figure.

For example, the information processing apparatus 1 provides map information indicating information indicating a sojourner characteristic at the position of each of two or more classification regions satisfying a predetermined condition among a plurality of classification regions. The predetermined condition is, for example, a condition that a size is equal to or larger than a predetermined size, a condition that the sojourner characteristic is a predetermined characteristic, and a condition that the number of sojourners is equal to or larger than a predetermined number but is not limited to such an example.

In the map information illustrated in FIG. 1, a character string of a title indicating the sojourner characteristic is shown on the map as information indicating sojourner characteristics in the regions. In the map information, a character string of a title indicating the sojourner characteristic in different colors according to types of the sojourner characteristic is displayed on the map. Accordingly, the service user O can easily grasp the sojourner characteristics in the regions.

As explained above, the information processing apparatus 1 acquires sojourner information including information concerning each of a plurality of sojourners in the specific region, classifies the specific region into a plurality of classification regions, which are a plurality of regions corresponding to the characteristics of the sojourners, based on the acquired sojourner information, and provides map information indicating information indicating the characteristics of the sojourners at the positions of each of two or more classification regions among the plurality of classification regions in the specific region. Accordingly, the information processing apparatus 1 can support an analysis of the specific region.

In the following explanation, a configuration and the like of an information processing system including the information processing apparatus 1 and the terminal device 2 that perform the processing explained above are explained in detail.

### [2. Configuration of the Information Processing System]

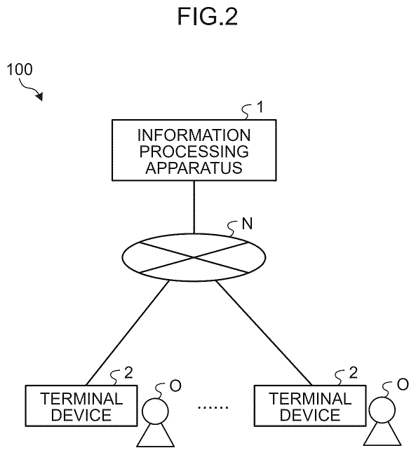

FIG. 2 is a diagram illustrating an example of a configuration of an information processing system according to the embodiment; As illustrated in FIG. 2, an information processing system 100 according to the embodiment includes the information processing apparatus 1 and a plurality of terminal devices 2.

The plurality of terminal devices 2 are used by different service users O. The terminal devices 2 are, for example, notebook PCs (Personal Computers), desktop PCs, smartphones, tablet PCs, or wearable devices. The wearable devices are, for example, smart glasses, smart watches, or the like but are not limited to such an example.

The information processing apparatus 1 and each of the terminal devices 2 are communicably connected to each other by wire or radio via a network N. Note that the information processing system 100 illustrated in FIG. 2 may include a plurality of information processing apparatuses 1 and the like.

The network N includes, for example, a WAN (Wide Area Network) such as the Internet and a mobile communication network such as LTE (Long Term Evolution), 4G (4th Generation), or 5G (5th Generation) but is not limited to such an example.

The terminal device 2 is connected to the network N via short-range wireless communication such as a mobile communication network, Bluetooth (registered trademark), or a LAN (Local Area Network) and can communicate with the information processing apparatus 1 and the like.

### [3. Configuration of the Information Processing Apparatus 1]

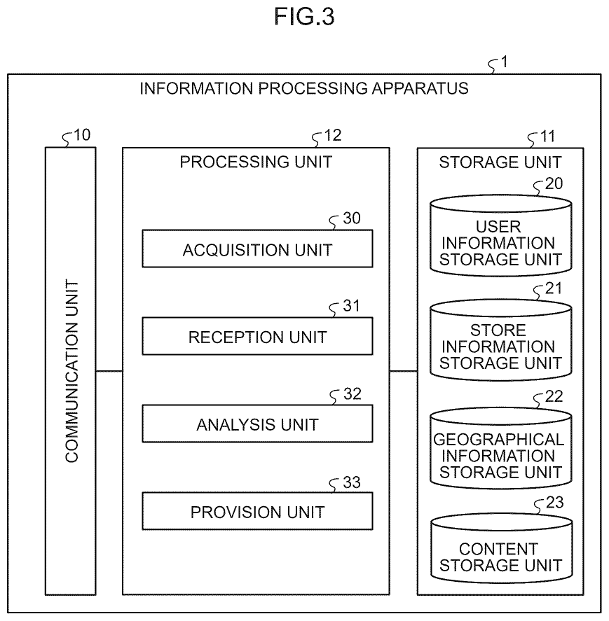

FIG. 3 is a diagram illustrating an example of a configuration of the information processing apparatus 1 according to the embodiment. As illustrated in FIG. 3, the information processing apparatus 1 includes a communication unit 10, a storage unit 11, and a processing unit 12.

### [3.1. Communication Unit 10]

The communication unit 10 is implemented by, for example, a communication module, a NIC (Network Interface Card), or the like. Then, the communication unit 10 is connected to the network N by wire or radio and transmits and receives information to and from various other devices. For example, the communication unit 10 transmits and receives information to and from the terminal device 2 via the network N.

### [3.2. Storage Unit 11]

The storage unit 11 is implemented by, for example, a semiconductor memory element such as a RAM (Random Access Memory) or a flash memory or a storage device such as a hard disk or an optical disk. The storage unit 11 includes a user information storage unit 20 and a geographical information storage unit 21.

### [3.2.1. User Information Storage Unit 20]

The user information storage unit 20 stores user information including information concerning users of various services. The various services include an online service, a terminal application service, and a store or facility service but are not limited to such an example.

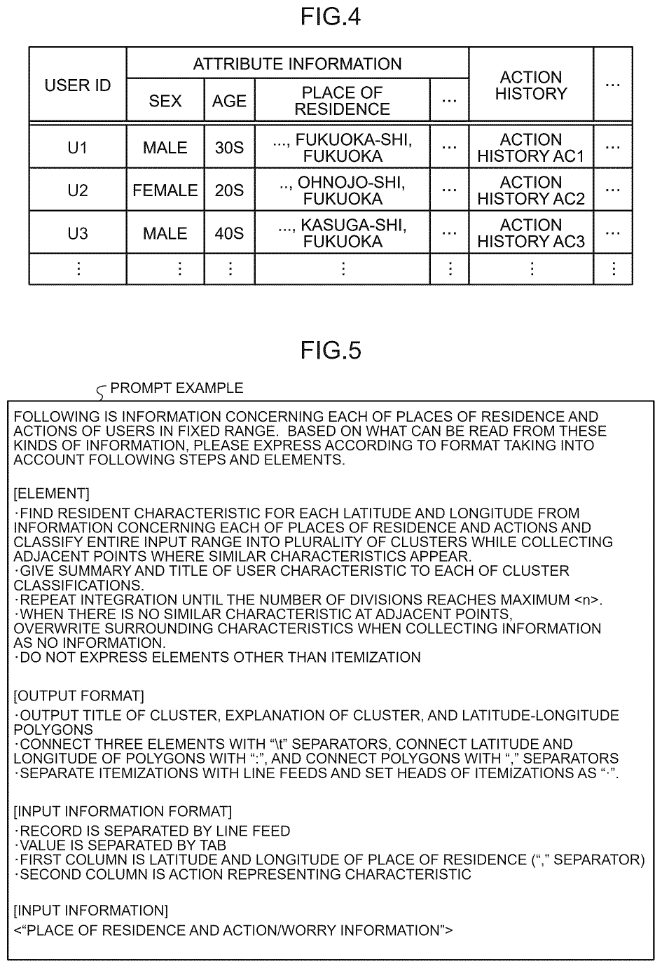

FIG. 4 is a diagram illustrating an example of a user information table stored in the user information storage unit 20 of the information processing apparatus 1 according to the embodiment. As illustrated in FIG. 4, the user information table stored in the user information storage unit 20 includes items such as a “user ID”, “attribute information”, and “action history”.

The “user ID” is identification information for identifying a user. The “attribute information” is attribute information of the user corresponding to the “user ID” and includes, for example, information of a psychographic attribute, information of a demographic attribute, and the like. The demographic attribute is, for example, sex, age, a place of residence, a place of visit, a place of work, and an occupation. The psychographic attribute is an object of interest such as travel, clothes, cars, and religion, a lifestyle, an idea, a tendency of an idea, and the like.

The “action history” is information indicating an action history of the user corresponding to the “user ID”. The information indicating the action history of the user is action information indicating the past action of the user. The action information indicating the action of the user includes, for example, information indicating an online action of the user and information indicating an offline action of the user.

The online action of the user is, for example, an online search action of the user (for example, a web search) and is online content browsing of the user. The online content is, for example, a blog article, a news article, video content, music content, and posted content to an SNS but is not limited to such an example.

The information indicating the offline action of the user includes, for example, information indicating a location (a store or a facility) used by the user and information indicating a use content thereof, information indicating means of transportation used by the user and information indicating a section thereof, and information indicating a moving route on which the user moved.

The use content of the use place that is the place used by the user include, for example, payment amounts and an average payment amount of the user at the use place, content and a genre of a purchased product or a purchased service of the user at the use place, and stay times and an average stay time of the user at the use place but is not limited to such an example. The payment amounts and the average payment amount of the user at the use place is, for example, settlement amounts an average settlement amount of the user at the use place but is not limited to such an example.

The user information table includes worry information indicating a worry of the use corresponding to the “user ID.” The worry information indicating the worry of the user is, for example, information indicating a worry concerning health, child raising, a personal relationship, a carrier, and household accounts and assets but is not limited to such an example. The worry concerning health is, for example, a worry concerning physical health such as illness and poor physical condition, and a worry concerning mental health such as stress and manic depression but is not limited to such an example.

The worry concerning child raising is, for example, a worry concerning growth of a child, a worry concerning child rearing of a child, a worry concerning school of a child, and a worry concerning infertility but is not limited to such an example. The worry concerning a personal relationship is, for example, a worry concerning a family relationship, a worry concerning a friendship, a worry concerning a relationship with a neighborhood resident, a worry concerning a love relationship, a worry concerning marriage, and a worry concerning communication but is not limited to such an example.

The worry about the carrier is, for example, a trouble about workplace relationship, a trouble about promotion, a trouble about job change, a trouble about skill improvement, and the like, but is not limited to such an example. The worry household accounts and assets is, for example, a worry concerning saving, a worry concerning investment, a worry concerning household accounts, and a worry concerning loans but is not limited to such an example.

### [3.2.2. Geographical Information Storage Unit 21]

The geographical information storage unit 21 stores geographical information including map information. The geographical information is, for example, information indicating topography of regions, information indicating passages in the regions, information indicating route of public institutions in the regions, information indicating traffic regulations and signs in the regions, information of news articles in the regions, information concerning disasters in the regions, information concerning facilities and stores in the regions, and weather information in the regions but is not limited to such an example.

### [3.3. Processing Unit 12]

The processing unit 12 is a controller and is implemented by, for example, a processor such as a CPU (Central Processing Unit) or an MPU (Micro Processing Unit) executing various programs (equivalent to an example of an information processing program) stored in a storage device inside the information processing apparatus 1 using a RAM or the like as a work region.

The processing unit 12 is a controller and a part or the entire processing unit 12 may be implemented by an integrated circuit such as an ASIC (Application Specific Integrated Circuit), an FPGA (Field Programmable Gate Array), or a GPGPU (General Purpose Graphic Processing Unit).

As illustrated in FIG. 3, the processing unit 12 includes a reception unit 30, an acquisition unit 31, a classification unit 32, and a provision unit 33, and implements or executes functions and action of information processing explained below. Note that the internal configuration of the processing unit 12 is not limited to the configuration illustrated in FIG. 3 and may be another configuration if the configuration is a configuration for performing information processing explained.

### [3.3.1. Reception Unit 30]

The reception unit 30 receives various kinds of information. For example, the reception unit 30 receives a map information request transmitted from the terminal device 2.

For example, the service user O operates the terminal device 2 and causes the terminal device 2 to transmit a map information request to the information processing apparatus 1. When receiving the map information request transmitted from the terminal device 2, the information processing apparatus 1 transmits the map information to the terminal device 2. When receiving the map information transmitted from the information processing apparatus 1, the terminal device 2 displays the received map information.

The service user O can designate a region desired to be set as a target of a region characteristic analysis in the map indicated by the map information displayed on the terminal device 2. When the region is designated by the service user O, the terminal device 2 transmits a region characteristic information request including, as designated region information, information indicating the region designated by the service user O to the information processing apparatus 1. Note that the region characteristic information request sometimes includes information such as designation of the specific condition and the time period explained above.

### [3.3.2. Acquisition Unit 31]

The acquisition unit 31 acquires various kinds of information from an external information processing apparatus, the terminal device 2, and the like via the network N and the communication unit 10.

For example, the acquisition unit 31 acquires user information from the external information processing apparatus and causes the user information storage unit 20 to store the acquired user information. The acquisition unit 31 acquires geographical information from an external information processing apparatus and causes the geographical information storage unit 21 to store the acquired geographical information.

The acquisition unit 31 acquires various kinds of information from the storage unit 11. For example, the acquisition unit 31 acquires information concerning a user from the user information storage unit 20 and acquires geographical information from the geographical information storage unit 21.

The acquisition unit 31 acquires, from the user information storage unit 20, sojourner information including information concerning each of a plurality of sojourners in a specific region that is the region, the designation of which has been received by the reception unit 30. The sojourner in the specific region is, for example, a resident who is a user residing in the specific region, a worker who is a user working in the specific region, or a visitor who is a user who has visited the specific region among a plurality of users whose information is stored in the user information storage unit 20.

The sojourner information includes sojourn position information indicating sojourn positions of the sojourners as the information concerning the sojourners. The sojourn position of the sojourner is a place of residence when the sojourner is a resident in the specific region, is a place of work when the sojourner is a worker in the specific region, and is a place of visit when the sojourner is a visit to the specific region.

The acquisition unit 31 can acquire, for example, sojourner information including information concerning one or more types of sojourners satisfying a specific condition among a plurality of types of sojourners including a resident, a place of work, and a visitor. The specific condition is, for example, information set by the service user O. The information indicating the specific condition is included in, for example, the region characteristic information request.

In addition, the sojourner information includes, as the information concerning the sojourners, one or more pieces of information satisfying the specific condition among action information indicating actions of the sojourners and worry information indicating worries of the sojourners. The action information indicating the actions of the sojourners includes, for example, information indicating online actions of the sojourners and information indicating offline actions of the sojourners.

The online actions of the sojourners are, for example, search actions (for example, web searches) of the sojourners, online content browsing of the sojourners, and the like. The online content is, for example, a blog article, a news article, video content, music content, and posted content to an SNS but is not limited to such an example.

The information indicating the offline actions of the sojourners includes, for example, information indicating places (stores and facilities) used by the sojourners and information indicating use content thereof, information indicating means of transportation used by the sojourners and information indicating sections thereof, and information indicating moving routes on which the sojourners moved.

The use content of the use places, which are the places used by the sojourners, includes, for example, payment amounts and an average payment amount of the sojourners at the use place, content and a genre of purchased commodities or purchased services of the sojourners at the use place, and stay times and an average stay time of the sojourners at the use place but is not limited to such an example. The payment amounts and the average payment amount of the sojourners at the use place are, for example, settlement amounts and an average settlement amount of the sojourners at the use place but are not limited to such an example.

The worry information indicating the worries of the sojourners is, for example, information indicating worries concerning health, child raising, personal relationships, carriers, household accounts, and assets but is not limited to such an example. The worry concerning health is, for example, a worry concerning physical health such as illness and poor physical condition, and a worry concerning mental health such as stress and manic depression but is not limited to such an example.

The worry concerning child raising is, for example, a worry concerning growth of a child, a worry concerning child rearing of a child, a worry concerning school of a child, and a worry concerning infertility but is not limited to such an example. The worry concerning a personal relationship is, for example, a worry concerning a family relationship, a worry concerning a friendship, a worry concerning a relationship with a neighborhood resident, a worry concerning a love relationship, a worry concerning marriage, and a worry concerning communication but is not limited to such an example.

The worry about the carrier is, for example, a trouble about workplace relationship, a trouble about promotion, a trouble about job change, a trouble about skill improvement, and the like, but is not limited to such an example. The worry household accounts and assets is, for example, a worry concerning saving, a worry concerning investment, a worry concerning household accounts, and a worry concerning loans but is not limited to such an example.

The specific condition may include a condition of a type of an action instead of or in addition to the condition of the type of the sojourner. In this case, the acquisition unit 31 acquires sojourner information including information concerning one or more types of action satisfying a specific condition. The type of the action is, for example, an action in an online action of the sojourner or an action in an online action of the sojourner but may be a type obtained by subdividing the actions.

For example, when receiving the region characteristic information request and when information concerning a time period designated by the service user O is included in the region characteristic information request, in step S2, the acquisition unit 31 acquires only information concerning action in a time period designated by the service user O.

### [3.3.3. Classification Unit 32]

The classification unit 32 classifies the specific region into a plurality of regions corresponding to characteristics of the sojourners based on the sojourner information acquired by the acquisition unit 31.

For example, the classification unit 32 finds characteristics of the sojourners for each latitude and longitude based on the sojourner information acquired by the acquisition unit 31 and classifies the entire specific region into a plurality of clusters corresponding to the characteristics of the sojourners while collecting adjacent points where similar characteristics appear. The clusters includes one or more regions in the specific region. The classification unit 32 determines titles of the classified clusters.

For example, when information satisfying a specific condition among action information indicating an action of the sojourner and worry information indicating a worry of the sojourner is the action information indicating the action of the sojourner, the classification unit 32 classifies the specific region into a plurality of clusters corresponding to characteristics of the action of the sojourner.

Characteristics of the action of the sojourner is, for example, one characteristic among a keyword or a category used by the sojourner in an online search (for example, a web search, a blog search, a news search, and an SNS search), a type or a genre of content browsed online by the sojourner, a place or a genre where the sojourner often goes, or means of transportation used by the sojourner or a combination of two or more characteristics among these characteristics but is not limited to such an example.

For example, when the information satisfying the specific condition among the action information indicating the action of the sojourner and the worry information indicating the worry of the sojourner is the action information indicating the worry of the sojourner, the classification unit 32 classifies the specific region into a plurality of clusters corresponding to a characteristic of the worry of the sojourner. The characteristics of the worries of the sojourners are, for example, the worries classified as explained above but are not limited to the example explained above and various classifications are possible.

The classification unit 32 performs the classification processing explained above using the generative AI. The generative AI is, for example, text generation AI. The text generative AI is, for example, a large-scale language model learned to estimate and output the next token from an input token string and is, for example, a transformer-based model or an RNN-based model but may be a mixed model these models. The text generative AI may be a composite system combined with an identification machine or the like for preventing unauthorized use.

The transformer-based model is, for example, GPT, PaLM2, or LLAMA but is not limited to such an example. The RNN-based model is, for example, RWKV but is not limited to such an example.

Note that the generative AI is desirably learned not to include personal information and the like in a generation result of the generative AI. The generative AI is disposed in an external information processing apparatus. The classification unit 32 uses the generative AI via an API. However, the generative AI may be disposed in the information processing apparatus 1.

For example, the classification unit 32 inputs, to the generative AI, a prompt including instruction information that is information indicating an instruction to classify a specific region into regions of a plurality of clusters according to characteristics concerning one or more of actions and worries of a plurality of sojourners and a part or all of the information acquired by the acquisition unit 31 and causes the generative AI to output information indicating the regions of the plurality of clusters into which the specific region has been classified.

For example, the classification unit 32 inputs, to the generative AI, a prompt including instruction information that is information indicating an instruction to classify a specific region into regions of a plurality of clusters according to characteristics of action of a plurality of sojourners and a part or all of the information acquired by the acquisition unit 31 and causes the generative AI to output information indicating regions of a plurality of clusters obtained by classifying the specific region according to the characteristics of the action of the sojourners.

The classification unit 32 inputs, to the generative AI, for example, a prompt including instruction information that is information indicating an instruction to classify a specific region into regions of a plurality of clusters according to characteristics of worries of a plurality of sojourners and a part or all of the information acquired by the acquisition unit 31 and causes the generative AI to output information indicating regions of a plurality of clusters obtained by classifying the specific region according to the characteristics of the worries of the sojourners.

The classification unit 32 inputs, to the generative AI, for example, a prompt including instruction information that is information indicating an instruction to classify a specific region into regions of a plurality of clusters according to characteristics indicated by combinations of actions and worries of a plurality of sojourners and a part or all of the information acquired by the acquisition unit 31 and causes the generative AI to output information indicating regions of a plurality of clusters into which the specific region is classified according to the characteristics indicated by the combination of the actions and the worries.

FIG. 5 is a diagram illustrating an example of a prompt used by the classification unit 32 of the processing unit 12 in the information processing apparatus 1 according to the embodiment. The classification unit 32 inputs the prompt illustrated in FIG. 5 to the generative AI and causes the generative AI to output information indicating regions of a plurality of clusters obtained by classifying the specific region according to the characteristics of the actions of the sojourners. The instruction information of the prompt illustrated in FIG. 5 also includes information concerning an output format that defines how to output information indicating regions of a plurality of clusters obtained by classifying the specific region according to the characteristics of the actions of the sojourners.

In the example illustrated in FIG. 5, the information concerning the output format is information of a character string “· Output a title of a cluster, explanation of the cluster, and latitude-longitude polygons \n. Connect three elements with “\t” separators, connect the latitude and the longitude of the polygons with “:”, and connect the polygons with “,” separators \n. Separate itemizations with line feeds, and set heads of the itemizations are set as “·””. Note that a part of the information other than the instruction information is omitted in the prompt illustrated in FIG. 5.

The classification unit 32 can classify one or more characteristics among the actions and the worries of the plurality of sojourners into two or more groups using a classification model instead of using the generative AI. The classification model is, for example, GBDT or a neural network but is not limited to such an example.

The generative AI may be multi-modal generative AI or the like. The multi-modal generative AI is, for example, generative AI that generates at least one of text, an image, and voice from at least one of text, an image, and voice. The multi-modal generative AI is, for example, GPT-4 Turbo with vision, or gemini, CM3Leon but is not limited to such an example.

Note that the classification unit 32 can perform the classification processing in step S3 with statistical processing instead of using the generative AI. For example, the classification unit 32 extracts top n characteristics among characteristics of the sojourners in a plurality of unit regions obtained by dividing the specific region. n is an integer equal to or larger than 2. Then, the classification unit 32 classifies the entire specific region into a plurality of clusters corresponding to the characteristics of the sojourners while collecting adjacent unit regions where the same or similar characteristics appear.

### [3.3.4. Provision Unit 33]

The provision unit 33 provides various kinds of information to the service user O. For example, the provision unit 33 provides various kinds of information to the service user O by transmitting the various kinds of information to the terminal device 2 via the communication unit 10 and the network N.

For example, when a map information request is received by the reception unit 30, the provision unit 33 transmits map information to the terminal device 2 to thereby provide the map information to the service user O.

When a region characteristic information request is received by the reception unit 30, the provision unit 33 provides, based on the classification result in the classification unit 32, map information indicating information indicating sojourner characteristics at the position of each of two or more classification regions among a plurality of classification regions, which are a plurality of regions classified by the classification unit 32 in the specific region. The provision unit 33 transmits the map information to the terminal device 2 to thereby provide the map information.

For example, the provision unit 33 transmits map information indicating information indicating sojourner characteristics at the position of each of the two or more classification regions to the terminal device 2 to thereby provide, to the service user O, the map information indicating the information indicating the sojourner characteristics at the position of each of the two or more classification regions.

The sojourner characteristic is a characteristic indicated by a characteristic of an action of the sojourner, a characteristic of a worry of the sojourner, or a combination of the action and the worry of the sojourner. The information indicating the sojourner characteristic is information indicating the sojourner characteristic with a character string (for example, a title) but may be information indicating the sojourner characteristic with a symbol or a figure or may be information indicating the sojourner characteristic with two or more of a character string, a symbol, and a figure.

The provision unit 33 provides, for example, map information indicating information indicating sojourner characteristics at the position of each of two or more classification regions satisfying a predetermined condition among the plurality of classification regions. The predetermined condition is, for example, a condition that a size is equal to or larger than a predetermined size, a condition that the sojourner characteristic is a predetermined characteristic, and a condition that the number of sojourners is equal to or larger than a predetermined number but is not limited to such an example.

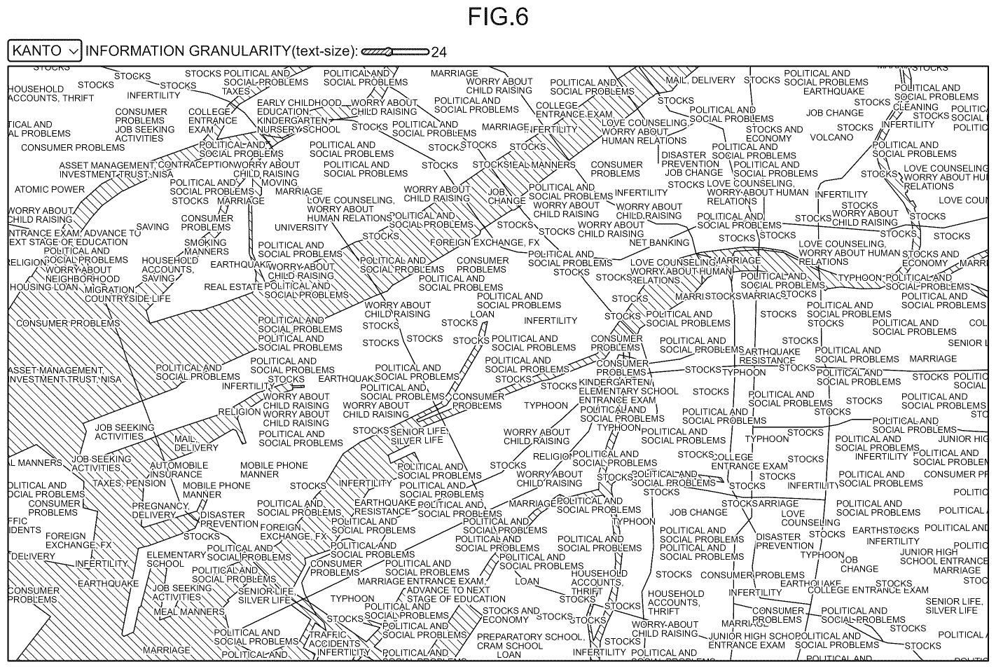

FIG. 6 is a diagram illustrating an example of map information provided by the provision unit 33 of the processing unit 12 in the information processing apparatus 1 according to the embodiment and displayed on the terminal device 2. In the map information illustrated in FIG. 6, character strings of titles indicating sojourner characteristics are shown on a map as information indicating sojourner characteristics in regions. In the map information, a character string of a title indicating the sojourner characteristic in different colors according to types of the sojourner characteristic is displayed on the map. Accordingly, the service user O can easily grasp the sojourner characteristics in the regions.

Note that, in the map information, the character strings of the titles can be highlighted in a color corresponding to the size of the number of sojourners classified into clusters corresponding to the titles and the character strings of the titles can be highlighted in a color corresponding to the size of regions corresponding to the clusters. Note that the highlighted display is not limited to a color of a font of the character string and may be the size of the font of the character string, the style of the font of the character string, or other display forms.

### [4. Processing Procedure]

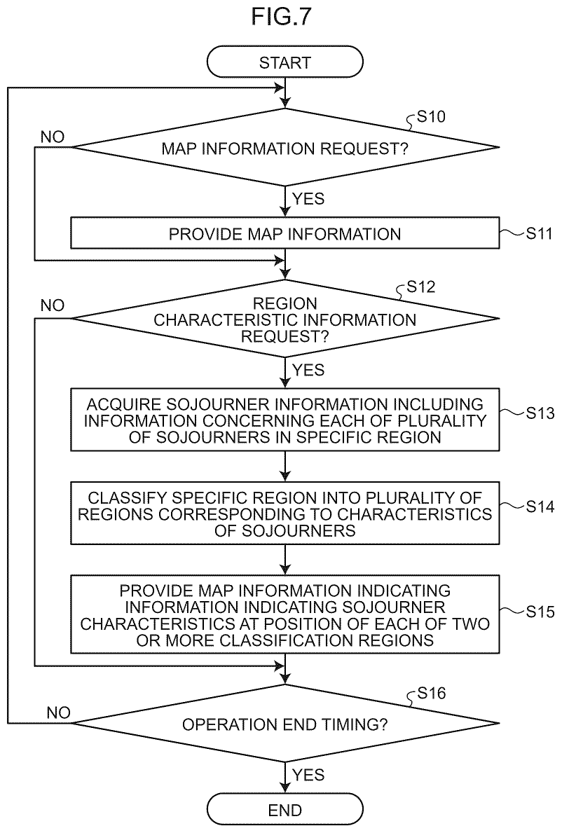

Subsequently, a procedure of information processing by the processing unit 12 of the information processing apparatus 1 according to the embodiment is explained. FIG. 7 is a flowchart illustrating an example of information processing by the processing unit 12 of the information processing apparatus 1 according to the embodiment.

As illustrated in FIG. 7, the processing unit 12 of the information processing apparatus 1 determines whether a map information request from the service user O has been received (step S10). When determining that the map information request from the service user O has been received (step S10: Yes), the processing unit 12 provides map information to the service user O (step S11).

When the processing in step S11 ends or when determining that the map information request from the service user O has not been received (step S10: No), the processing unit 12 determines whether a region characteristic information request from the service user O has been received (step S12).

When determining that the region characteristic information request from the service user O has been received (step S12: Yes), the processing unit 12 acquires sojourner information including information concerning each of the plurality of sojourners in the specific region from the storage unit 11 or the like (step S13). Then, the processing unit 12 classifies the specific region into a plurality of regions corresponding to characteristics of the sojourners based on the information acquired in step S13 (step S14) and provides map information indicating information indicating the sojourner characteristics at the position of each of two or more classification regions (step S15).

When the processing in step S15 ends or when determining that the region characteristic information request from the service user O has not been received (step S12: No), the processing unit 12 determines whether operation end timing has come (step S16). For example, when the information processing apparatus 1 is turned off, the processing unit 12 determines that the operation end timing has come.

When determining that the operation end timing has not come (step S16: No), the processing unit 12 shifts the processing to step S10. When determining that the operation end timing has come (step S16: Yes), the processing unit 12 ends the processing illustrated in FIG. 7.

### [5. Modifications]

The classification unit 32 can also classify the specific region into a plurality of regions corresponding to the characteristics of the sojourners for each predetermined period based on sojourner information for each predetermined period. In this case, the provision unit 33 can also provide map information shown on a map while automatically switching, in time series, information indicating a characteristic at the position of each of two or more regions among a plurality of regions in the specific region.

For example, the classification unit 32 can also divide the classification processing into a plurality of kinds of processing. For example, the classification unit 32 can perform, as comparison processing, a plurality of kinds of processing including first processing of determining characteristics (for example, a plurality of characteristics) of sojourners in a plurality of unit regions obtained by dividing the specific region and second processing of collecting results of the first processing. The second processing is, for example, processing of classifying the entire specific region into a plurality of clusters corresponding to the characteristics of the sojourners while collecting adjacent unit regions where the same or similar characteristics appear.

In this case, the classification unit 32 inputs, to generative AI, a prompt including instruction information for instructing determination of characteristics of the sojourners in the plurality of unit regions obtained by dividing the specific region and information necessary for determination of the characteristics of the sojourners in the plurality of unit regions obtained by dividing the specific region and causes the generative AI to output information indicating the characteristics of the sojourners in the plurality of the unit regions obtained by dividing the specific region. Note that the first processing may be performed for each unit region.

In the second processing, the classification unit 32 inputs, to the generative AI, a prompt including instruction information for instructing classification of the entire specific region into a plurality of clusters corresponding to the characteristics of the sojourners and information indicating a determination result of the first processing while collecting adjacent unit regions where the same or similar characteristics appear and causes the generative AI to output information indicating a classification result of the entire specific region into the plurality of clusters corresponding to the characteristics of the sojourner.

### [6. Hardware Configuration]

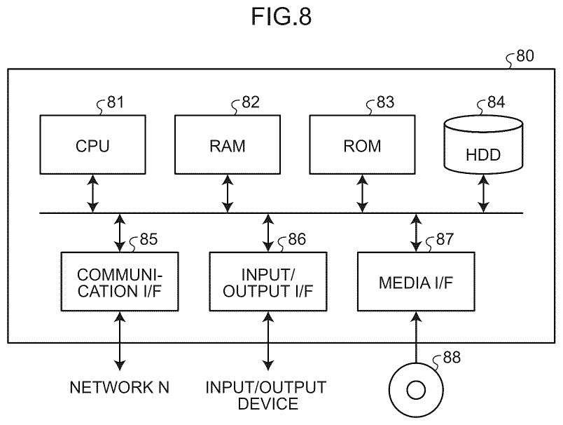

The information processing apparatus 1 according to the embodiment explained above is implemented by, for example, the computer 80 having a configuration as illustrated in FIG. 8. FIG. 8 is a hardware configuration diagram illustrating an example of the computer 80 that implements the functions of the information processing apparatus 1 according to the embodiment. The computer 80 includes a CPU 81, a RAM 82, a ROM (Read Only Memory) 83, an HDD (Hard Disk Drive) 84, a communication interface (I/F) 85, an input/output interface (I/F) 86, and a media interface (I/F) 87.

The CPU 81 operates based on a program stored in the ROM 83 or the HDD 84 and controls the units. The ROM 83 stores a boot program to be executed by the CPU 81 when the computer 80 is started, a program relying on hardware of the computer 80, and the like.

The HDD 84 stores a program to be executed by the CPU 81, data to be used by the program, and the like. The communication interface 85 receives data from other devices via the network N (see FIG. 2), sends the data to the CPU 81, and transmits data generated by the CPU 81 to the other devices via the network N.

The CPU 81 controls output devices such as a display and a printer and an input device such as a keyboard or a mouse via the input/output interface 86. The CPU 81 acquires data from the input device via the input/output interface 86. The CPU 81 outputs the generated data to the output device via the input/output interface 86.

The media interface 87 reads a program or data stored in the recording medium 88 and provides the program or the data to the CPU 81 via the RAM 82. The CPU 81 loads the program from the recording medium 88 onto the RAM 82 via the media interface 87 and executes the loaded program. The recording medium 88 is, for example, an optical recording medium such as a DVD (Digital Versatile Disc) or a PD (Phase change rewritable Disk), a magneto-optical recording medium such as an MO (Magneto-Optical disk), a tape medium, a magnetic recording medium, or a semiconductor memory.

For example, when the computer 80 functions as the information processing apparatus 1 according to the embodiment, the CPU 81 of the computer 80 implements the function of the processing unit 12 by executing the program loaded on the RAM 82. The HDD 84 stores data in the storage unit 11. The CPU 81 of the computer 80 reads these programs from the recording medium 88 and executes the programs. However, as another example, the CPU 81 may acquire these programs from another device via the network N.

### [7. Others]

Among the kinds of processing explained in the embodiment explained above, all or a part of the processing explained as being automatically performed can be manually performed or all or a part of the processing explained as being manually performed can be automatically performed by a publicly-known method. Besides, the processing procedures, the specific names, and the information including various data and parameters explained and illustrated in the document explained above and the drawings can be optionally changed except when being specifically described. For example, the various kinds of information illustrated in the figures are not limited to the illustrated information.

The components of the devices illustrated in the figures are functionally conceptual and are not always required to be physically configured as illustrated. That is, a specific form of distribution and integration of the devices is not limited to the illustrated form and all or a part of the devices can be functionally or physically distributed and integrated in any unit according to various loads, usage situations, and the like.

The configuration of the information processing apparatus 1 explained above can be flexibly changed, for example, the information processing apparatus 1 may be implemented by a terminal device and a server computer, may be implemented by a plurality of server computers, or may be implemented by calling an external platform or the like with an API, network computing, or the like depending on functions.

The embodiment and the modifications explained above can be combined as appropriate within a range that does not contradict the processing contents.

### [8. Effects]

As explained above, the information processing apparatus 1 according to the embodiment includes the acquisition unit 31, the classification unit 32, and the provision unit 33. The acquisition unit 31 acquires sojourner information including a plurality of pieces of information in the specific region. The classification unit 32 classifies the specific region into a plurality of regions corresponding to characteristics of the sojourners based on the sojourner information acquired by the acquisition unit 31. The provision unit 33 provides map information indicating information indicating characteristics at the position of each of two or more regions among a plurality of regions in the specific region. Accordingly, the information processing apparatus 1 can support an analysis of the specific region.

The acquisition unit 31 acquires, as the sojourner information, information including sojourn position information indicating a sojourn position of each of a plurality of sojourners and action information indicating an action of each of the plurality of sojourners. The classification unit 32 classifies the specific region into a plurality of regions corresponding to characteristics of actions of the sojourners based on the sojourner information acquired by the acquisition unit 31. Accordingly, the information processing apparatus 1 can further support the analysis of the specific region.

The acquisition unit 31 acquires, as the sojourner information, information including sojourn position information indicating a sojourn position of each of the plurality of sojourners and a plurality of pieces of worry information indicating a worry of each of the plurality of sojourners. The classification unit 32 classifies the specific region into a plurality of regions corresponding to a characteristics of worries of the sojourners based on the sojourner information acquired by the acquisition unit 31. Accordingly, the information processing apparatus 1 can further support the analysis of the specific region.

The provision unit 33 provides map information indicating information indicating characteristics at the position of each of two or more regions satisfying a predetermined condition among the plurality of regions. Accordingly, the information processing apparatus 1 can further support the analysis of the specific region.

The predetermined condition is a condition that a size is equal to or larger than a predetermined size. Accordingly, the information processing apparatus 1 can further support the analysis of the specific region.

The predetermined condition is a condition that a characteristic is a predetermined characteristic. Accordingly, the information processing apparatus 1 can further support the analysis of the specific region.

The predetermined condition is a condition that the number of sojourners is equal to or larger than a predetermined number. Accordingly, the information processing apparatus 1 can further support the analysis of the specific region.

Each of the plurality of sojourners is a resident in the specific region, and the position information is information indicating a place of residence of each of the plurality of sojourners. Accordingly, the information processing apparatus 1 can further support the analysis of the specific region.

Each of the plurality of sojourners is a visitor to the specific region. The position information is information indicating a place of visit of each of the plurality of sojourners. Accordingly, the information processing apparatus 1 can further support the analysis of the specific region.

Although the embodiment of the present application is explained above in detail with reference to the drawings, this is merely exemplification, and the present invention can be implemented in other forms to which various modifications and improvements are applied based on the knowledge of those skilled in the art, including the aspects described in the disclosure of the invention.

The “section, module, and unit” explained above can be replaced with “means”, “circuit”, and the like. For example, the acquisition unit can be replaced with acquiring means or an acquisition circuit.

What is claimed is:

1. An information processing apparatus comprising:
an acquisition unit that acquires sojourner information including information concerning each of a plurality of sojourners in a specific region;
a classification unit that classifies the specific region into a plurality of regions corresponding to characteristics of the sojourners based on the sojourner information acquired by the acquisition unit; and
a provision unit that provides map information indicating information indicating the characteristics at a position of each of two or more regions among the plurality of regions in the specific region.

2. The information processing apparatus according to claim 1, wherein
the acquisition unit acquires, as the sojourner information, information including sojourn position information indicating a sojourn position of each of the plurality of sojourners and action information indicating an action of each of the plurality of sojourners, and
the classification unit classifies the specific region into a plurality of regions corresponding to characteristics of actions of the sojourners based on the sojourner information acquired by the acquisition unit.

3. The information processing apparatus according to claim 1, wherein
the acquisition unit acquires, as the sojourner information, information including sojourn position information indicating a sojourn position of each of the plurality of sojourners and a plurality of pieces of worry information indicating a worry of each of the plurality of sojourners, and
the classification unit classifies the specific region into a plurality of regions corresponding to characteristics of the worries of the sojourner based on the sojourner information acquired by the acquisition unit.

4. The information processing apparatus according to claim 1, wherein
the provision unit provides map information indicating information indicating the characteristics at a position of each of two or more regions satisfying a predetermined condition among the plurality of regions.

5. The information processing apparatus according to claim 4, wherein
the predetermined condition is a condition that a size is equal to or larger than a predetermined size.

6. The information processing apparatus according to claim 4, wherein
the predetermined condition is a condition that the characteristic is a predetermined characteristic.

7. The information processing apparatus according to claim 4, wherein
the predetermined condition is a condition that a number of the sojourners is equal to or larger than a predetermined number.

8. The information processing apparatus according to claim 2, wherein
each of the plurality of sojourners is a resident in the specific region, and
the sojourner information is information indicating a place of residence of each of the plurality of sojourners.

9. The information processing apparatus according to claim 2, wherein
each of the plurality of sojourners is a visitor to the specific region, and
the sojourner information is information indicating a place of visit of each of the plurality of sojourners.

10. An information processing method executed by a computer, the method comprising:
an acquiring step of acquiring sojourner information including information concerning each of a plurality of sojourners in a specific region;
a classification step of classifying the specific region into a plurality of regions corresponding to characteristics of the sojourners based on the sojourner information acquired in the acquiring step; and
a providing step of providing map information indicating information indicating the characteristics at a position of each of two or more regions among the plurality of regions in the specific region.

11. A non-transitory computer-readable storage medium storing an information processing program for causing a computer to execute:
an acquiring procedure of acquiring sojourner information including information concerning each of a plurality of sojourners in a specific region;
a classification procedure of classifying the specific region into a plurality of regions corresponding to characteristics of the sojourners based on the sojourner information acquired by the acquiring procedure; and
a provision procedure of providing map information indicating information indicating the characteristics at a position of each of two or more regions among the plurality of regions in the specific region.
